(19) United States
(12) Patent Application Publication
(10) Pub. No.: US 2026/0158955 A1
(43) Pub. Date: Jun. 11, 2026

(54) CHARGING CONTROL APPARATUS AND METHOD

(71) Applicant: Roy Luther Johnson, III, Winter Garden, FL (US)

(72) Inventor: Roy Luther Johnson, III, Winter Garden, FL (US)

(73) Assignee: Cart IoT, LLC, Winter Garden, FL (US)

(21) Appl. No.: 19/414,234

(22) Filed: Dec. 9, 2025

Related U.S. Application Data
(60) Provisional application No. 63/730,378, filed on Dec. 10, 2024.

(51) Int. Cl. B60L 53/62; B60L 50/64; B60L 53/16; B60L 53/66; B60L 53/68; B60R 16/023; G07C 5/00

(52) U.S. Cl. CPC B60L 53/62; B60L 50/64; B60L 53/16; B60L 53/66; B60L 53/68; B60L 2240/12; B60L 2240/26; B60L 2240/70; B60R 16/0231; G07C 5/008

(57) ABSTRACT

A system, method, and apparatus for autonomously managing the charging and configuration of a low-speed electric vehicle (LSV). The apparatus comprises a charging port configured to be mounted to the vehicle, which interfaces with the vehicle's internal communication bus to monitor real-time battery status and vehicle state. A controller within the port automatically governs power delivery from an external source via a switching mechanism, configured to interrupt charging upon detection of safety faults, temperature anomalies, or pre-programmed schedules. The system may further include a zero-cross detection circuit to identify switching failures and a persistent internal power source for maintaining schedules without external network connectivity. Additional aspects include a power distribution unit for the centralized management of vehicle accessories and associated lighting modules, all of which may be monitored and configured via a remote server or mobile application.

### CROSS REFERENCE TO RELATED APPLICATION

This application priority to U.S. Provisional Patent Application No. 63/730,378 , filed on Dec. 10, 2024, the disclosure of which is hereby incorporated by reference in its entirety.

### TECHNICAL FIELD

The present application relates to methods, systems, and apparatuses for charging and modifying an electric vehicle.

### BACKGROUND

Recreational low-speed electric vehicles (LSVs) have become increasingly prevalent in the consumer market. Electric golf carts, for example, have been adapted for private and community use. However, the power systems currently employed in these vehicles are often based on legacy designs and present significant safety hazards. Specifically, documented instances exist where unattended LSVs, during storage or charging, have resulted in catastrophic thermal events, causing substantial property damage, severe injuries, or fatalities. Current LSV systems lack sufficient safety protocols and fail to provide the vehicle owner with adequate, real-time information regarding critical operational parameters, including the charging state.

Furthermore, current LSV owners frequently express dissatisfaction with the limited ability to customize the vehicle's performance characteristics. Specifically, users are often precluded from modifying power control settings to adjust vehicle performance, such as maximum speed. Consequently, there is an unmet need for an intelligent user experience and control system for LSV owners that addresses these safety and customization shortcomings.

### BRIEF DESCRIPTION OF THE DRAWINGS

Aspects of the present disclosure are illustrated by way of example and are not limited by the accompanying figures for which like references indicate like elements.

FIG. 1. is an exemplary computer system that may be used in accordance with the embodiments described herein.

FIG. 2 is an exemplary block diagram of a system, which includes a charging location, for charging and modifying an electric vehicle in accordance with the embodiments described herein.

FIG. 3 is an exemplary block diagram of a system, which includes a low-speed vehicle, for charging and modifying an electric vehicle in accordance with the embodiments described herein.

FIG. 4 is an exemplary block diagram of a system, which includes an intelligent charging port, for charging and modifying an electric vehicle in accordance with the embodiments described herein.

FIG. 5 is an exemplary flow diagram illustrating a process for charging and modifying an electric vehicle in accordance with the embodiments described herein.

FIG. 6 is an exemplary flow diagram illustrating a process for establishing a wireless connection used in the charging and modifying of an electric vehicle in accordance with the embodiments described herein.

FIG. 7 is an exemplary flow diagram illustrating a process for establishing a connection with a vehicle data bus, the vehicle-data-bus connection being used in the charging and modifying of an electric vehicle in accordance with the embodiments described herein.

FIG. 8 is an exemplary block diagram of a system, which includes an intelligent charging port disposed within a low-speed vehicle, for charging and modifying an electric vehicle in accordance with the embodiments described herein.

FIGS. 9A and 9B are two exemplary screenshots of a mobile application that may be used in a system for charging and modifying an electric vehicle in accordance with the embodiments described herein.

### SUMMARY

The following summary is provided to facilitate an understanding of some of the innovative features unique to the present disclosure and is not intended to be a full description. A full appreciation of the disclosure can be gained by taking the entire specification, claims, drawings, and abstract as a whole.

In one embodiment, the present disclosure provides a charging control apparatus for a low-speed electric vehicle. The apparatus comprises a housing configured to be mounted to a body of the low-speed electric vehicle. Supported by the housing is a power input connector configured to couple with an external power source and a power output connector configured to deliver electrical power to a battery system of the low-speed electric vehicle. A switching circuit, having both an open state and a closed state, is disposed electrically between the power input connector and the power output connector to selectively permit or interrupt the flow of power.

The apparatus further includes a communication interface circuit configured to communicatively couple with a data bus of the low-speed electric vehicle. A controller, comprising a processor and a non-transitory computer-readable memory, is electrically coupled to both the switching circuit and the communication interface circuit. The controller is configured to receive vehicle state data via the communication interface circuit, compare the vehicle state data to a stored threshold value, and transmit a control signal to the switching circuit to transition from the closed state to the open state when the vehicle state data exceeds the stored threshold value.

In another embodiment, the present disclosure provides a method for managing the charging of a low-speed electric vehicle. The method includes receiving, at a charging control port mounted to the low-speed electric vehicle, alternating current (AC) power from an external source. The method further involves establishing a data connection between the charging control port and a controller area network (CAN) bus of the low-speed electric vehicle and receiving, via the data connection, battery status data from a battery management system of the vehicle.

The method also includes measuring, via a sensor integrated into the charging control port, an operating parameter of the charging control port. A processor within the charging control port determines that a fault condition exists when the battery status data exceeds a stored charge limit or when the operating parameter exceeds a stored safety threshold. In response to determining that the fault condition exists, the method includes automatically actuating a switching circuit within the charging control port to disconnect the AC power from the low-speed electric vehicle.

### DETAILED DESCRIPTION

The present disclosure relates generally to electric vehicle power systems, and more specifically to methods, systems, and apparatuses for the intelligent charging, power distribution, and performance modification of low-speed electric vehicles (LSVs), such as golf carts.

Current power systems used in consumer electric vehicles often rely on antiquated “pass-through” charging architectures that lack intelligence, connectivity, or safety monitoring. These existing systems present significant risks, including the potential for undetected malfunctions that can lead to battery fires, property damage, and injury. Furthermore, owners of these vehicles currently lack the ability to remotely monitor charging status, schedule power delivery, or easily modify vehicle performance settings.

Embodiments of the present invention address these needs by providing an intelligent charging ecosystem integrated directly into the vehicle. In one aspect, an intelligent charging port is provided that physically replaces or augments the standard charging receptacle. This device includes a controller and a switching mechanism capable of selectively interrupting power from an external source based on real-time data. Unlike traditional ports, this apparatus interfaces directly with the vehicle's communication bus (e.g., CAN bus) to read critical state information, such as battery charge levels and system health. It utilizes on-board sensors, such as temperature sensors and voltage detection circuits, to actively monitor for hazardous conditions—such as a “stuck relay” or overheating—and automatically disconnects power to prevent damage.

In another aspect, the invention provides an intelligent power distribution unit that centrally manages and protects vehicle accessories, such as lighting, audio systems, and motor controllers. This unit replaces standard fuse blocks with a smart, programmable interface that allows users to customize accessory behavior and power settings via a mobile or web application.

Key advantages of the disclosed embodiments include The ability to automatically detect and respond to unsafe charging conditions, such as overheating or mechanical relay failures, significantly reducing fire risks; a persistent internal power store allows the system to execute charging schedules and safety checks even when network connectivity is unavailable; smart connectivity in that users can remotely monitor their vehicle's status, receive real-time alerts regarding charging faults, and modify performance parameters (e.g., speed or range tuning) through a unified software platform; and the system collects energy consumption metrics and performance data, enabling efficient management and predictive maintenance for vehicle fleets.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

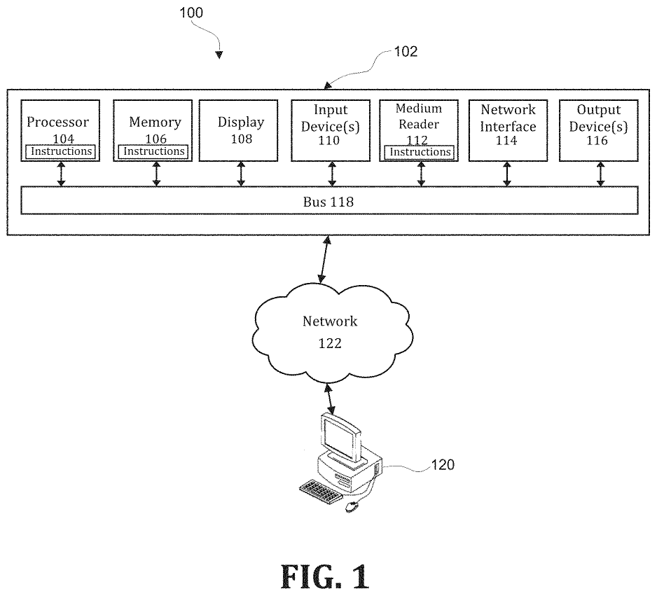

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, WiFi, Bluetooth, Bluetooth Low Energy (BLE), Thread, Z-Wave, LoRaWAN, Cellular, MQTT, NBIoT, Zigbee, infrared, near field communication (NFC), radio frequency identification (RFID), ultra-wideband (UWB), wireless wide area network (WWAN), wireless local area network (WLAN), wireless personal area network (WPAN), or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized methods and systems for charging and modifying an electric vehicle, including but not limited to a low-speed electrical vehicle. The various embodiments provide optimized methods and systems that increase convenience, control, safety, and peace-of-mind related to unattended charging, remote charging, and long-term storage. Furthermore, various embodiments provide owners of individual vehicles or vehicle fleets (e.g., in a community, resort, or golf course) with simplified management and maintenance of their vehicle(s).

As used herein, the term “low-speed electric vehicle” (LSV) refers to a wheeled vehicle that is optimized for low-speed transport. LSVs may include, e.g., golf carts, golf cars, neighborhood electric vehicles (NEVs), and personal transportation vehicles (PTVs). This definition explicitly encompasses vehicles that may or may not strictly adhere to the federal definition under 49 CFR § 571.500 but share similar physical characteristics, e.g., a gross vehicle weight rating (GVWR) of less than 3,000 pounds (1,361 kg) and/or a maximum attainable speed of generally less than 25 miles per hour (40 km/h). The term “Low-Speed Vehicle” as used herein expressly excludes “highway-capable vehicles” or “standard passenger automobiles,” which may be defined as vehicles designed for sustained travel at speeds exceeding 45 miles per hour and which are subject to full Federal Motor Vehicle Safety Standards (FMVSS) for crashworthiness (e.g., 49 CFR § 571.208). The present invention addresses technical challenges unique to the LSV and golf cart architecture. One technical challenge, e.g., is the frequent absence of sophisticated battery thermal management systems found in highway-capable electric vehicles. In one embodiment, an LSV has a maximum speed is less than 25 miles per hour (40 km/h). An LSV may, e.g., have a gross vehicle weight rating (GVWR) of less than 3,000 pounds (1,361 kg). In one embodiment, an LSV is equipped with one or more safety features mandated by federal standards (e.g., 49 CFR 571.500). Exemplary safety features include but are limited to headlamps, stop lamps, turn signal lamps, tail lamps, reflex reflectors, parking brakes, rearview mirrors, windshields, seat belts, and vehicle identification numbers (VINs). LSVs may be used in, e.g., master-planned communities, industrial campuses, and low-speed public roadways.

In the context of the present disclosure, a Low-Speed Vehicle (LSV) is distinct from standard passenger automobiles and trucks not merely in size, but in regulatory classification and fundamental construction. Defined under 49 CFR § 571.500, an LSV is restricted to a maximum speed of 25 mph and a gross vehicle weight rating (GVWR) of less than 3,000 lbs. Unlike full-speed electric vehicles (EVs) which are subject to comprehensive crash-test standards and require high-voltage safety interlocks (typically >300V), LSVs operate in a distinct regulatory and physical category often utilizing lower voltage architectures (e.g., 48V or 72V) and simplified chassis designs. Therefore, prior art references directed toward high-speed, highway-capable automotive systems address engineering challenges—such as high-speed thermal management, regenerative braking at highway velocities, and crash-safety mandated disconnects—that are technically inapplicable or functionally distinct from the constraints and requirements of an LSV.

Furthermore, the electrical architecture of an LSV differs fundamentally from that of a modern full-speed electric vehicle. Modern highway-capable EVs utilize standardized smart-charging protocols (e.g., J1772, CCS) where the vehicle and the external charging station (EVSE) natively communicate via dedicated pilot signals to negotiate power delivery before current flows. In contrast, LSVs traditionally rely on “dumb” charging interfaces (e.g., standard NEMA 5-15 receptacles) that lack any native communication or negotiation capabilities. The present invention solves a problem specific to this LSV architecture: the absence of inherent intelligence at the grid connection point. While a full-speed EV relies on the external EVSE for safety logic, the present invention integrates that logic into the vehicle itself, retrofitting modern safety and management capabilities onto a platform that, unlike a standard automobile, was not originally designed with them.

Finally, the operational profile of an LSV creates distinct charging requirements compared to standard automobiles. Standard EVs are primary transportation vehicles, typically driven daily and charged rapidly. In contrast, LSVs often serve as secondary vehicles in, e.g., recreational or campus settings, frequently subjected to extended periods of dormancy (e.g., seasonal storage). This usage pattern creates unique failure modes, such as battery sulfation or thermal runaway during unattended trickle charging, which standard automotive prior art does not address. The present invention provides autonomous monitoring specifically designed for these long-duration, unattended storage scenarios common to LSVs, a field of use that is divergent from the rapid-turnaround charging cycles optimized in standard automotive patents.

As used herein, the term “Intelligent Charging Port” (and widely “smart port” or “smart receptacle”) may refer broadly to a charging control apparatus comprising a combination of a physical power connector, a programmable logic controller (PLC) or microprocessor, memory, and a switching circuit, all integrated within a common housing or assembly. In one embodiment, unlike a passive electrical receptacle which merely acts as a conduit for current, an Intelligent Charging Port may be configured to actively monitor electrical parameters (e.g., current, voltage, temperature), communicate with external data buses (e.g., a vehicle CAN bus). The Intelligent Charging Port may selectively permit or interrupt the flow of electrical power based on logic stored within its memory or received from an external network. Therefore, in some embodiments, references to an “Intelligent Charging Port” may be understood as referring to the structural hardware components described in the figures, specifically the controller-based switching assembly capable of logic-based power modulation.

As used herein, the terms “intelligent,” “smart,” and “logic-based” may refer to the capability of the charging control apparatus to autonomously execute decision-making processes based on variable data inputs, rather than, for example, merely acting as a passive conduit for electrical power. In one embodiment, unlike standard charging receptacles that provide a continuous electrical path whenever physically connected, the “intelligence” may be characterized by a controller's ability to, e.g., actively interrogate the state of the vehicle (e.g., via the CAN bus), monitor local environmental conditions (e.g., via temperature sensors), or reference stored logic or schedules (e.g., via a real-time clock). The system may be deemed “intelligent” because it may, for example, perform one or more of dynamically modifying its own operational state, terminating power delivery, or altering a charging profile. Performing such function(s) may be, e.g., in response to real-time data inputs, and further, such function(s) may be performed without requiring manual human intervention.

### Intelligent Charging Port

According to one aspect of the invention, a “intelligent” power port for an electric vehicle, such as a golf cart or other low-speed vehicle (LSV), is provided. The intelligent power port may be attached to the body of the vehicle such that an external power source may be connected to the intelligent power port. The intelligent power port may use an internal switching mechanism to control power delivery to one or more of the vehicle's systems. The switching mechanism may include a mechanical power relay, a solid state switching device, or another other switching mechanism. The switching mechanism may provide high-power throughput.

Existing low-power electric vehicle charging solutions merely offer a basic “pass-through” electrical outlet with a female receptacle outlet on the external side of the vehicle, a power receptacle connector (or plug) inside the battery well, and an underseat compartment for connection to vehicle power system. Such existing electric vehicle charging systems are dangerous—charging malfunctions in the vehicles they charge have resulted in fires that often go unnoticed and thereby cause significant damage, injury, and sometimes death. Existing electric vehicle charging solutions neither adequately monitor conditions nor provide a user (e.g., vehicle owner) with any indication of a malfunction or unsafe condition. Existing electric vehicle charging solutions further provide no ability to remotely monitor delivery, no ability to control power delivery, and no ability to schedule power delivery integrated into the vehicle. Aspects of the present invention solve these problems.

In one embodiment, for example, a intelligent control module is introduced in the middle of the traditional pass-thru receptacle. The intelligent control module may be powered by line voltage when operated. A persistent internal power store may allow for maintaining time and date for scheduled operation. A vehicle communication bus interface may further be provided to allow for vehicle data and state information to be received and communicated to a server back end and/or user application. As such, the vehicle data and state information may be used for reporting, analysis, and decision-making. For example, such data and state information may be used to make manual or automated decisions regarding vehicle power and vehicle control. The interface may provide for tuning and adjustment of connected devices available on the communication bus. Connected devices available on the communication bus may include but are not limited to a battery, a charging system, a motor/speed controller, an infotainment unit, and other modules/devices.

In one embodiment, a detection circuit may be provided. The detection circuit may be disposed on the load side of the control/switching mechanism and may monitor and/or compare a state requested by a user to a state being observed. The detection circuit may identify events such as a tripped circuit breaker or other upstream power interruption. In one non-limiting embodiment, the detection circuit allows for the detection of a failed internal component that poses a hazardous condition. For example, the detection circuit may allow for the detection of a “stuck relay,” which may be a relay set to an “OFF” state that failed to open. Upon detecting an event, a notification may be sent to a user, a process to resolve the event may be initiated, or both. In one embodiment, an automated process to fix the hazardous condition may be initiated and completed. In another embodiment, instructions or recommendations may be sent to the user to manually repair the hazardous condition. The system may be configured to allow the user to choose whether to allow the system to automatically attempt to repair hazardous conditions or require manual interventions, and the system may be configured with custom settings based on the type of hazardous condition encountered.

In another embodiment, a temperature sensor may be provided. The temperature sensor, alone or in combination with other components/modules, may be configured to perform tasks including but not limited to monitoring temperature conditions, interrupting power delivery at user-defined temperature thresholds, or sending alarms or notifications to a user, e.g., when the temperature falls below or exceeds a user-defined temperature threshold. The system may be configured to automatically provide a predetermined permissible temperature range, and the system may allow the user to modify such range.

The electronic device may be connected to the vehicle's Controller Area Network (CAN) bus or other control network for existing components. The electronic device may include a wireless interface or other two-way connection interface to one or more of a plurality of sensors (e.g., sensors built into the intelligent charging port). As such, the electronic device may send and receive information from a variety of sources or components within or connected to the vehicle. Such connections to and information from such sources may be analyzed to provide optimal conditions (e.g., charging parameters) and/or may be used to control and report on charging sessions.

Control of the device may be achieved via a mobile application and/or web application, either or both of which may be connected to a back end server. The device may be configured to operate according to a predetermined charging schedule regardless of whether internet or network connectivity is available. Interval-based or periodic schedules may be defined along with a charging duration. The device may activate immediately for power delivery if no custom setup has been completed, and the device may terminate power delivery after a predefined duration has elapsed. The system may use a mobile application and a wireless connection to provide a user with schedule control, vehicle control, alerts, and monitoring of vehicle systems and status.

An external housing assembly of the device may include a user interaction and a control interface. In one embodiment, the user interaction and control interface may be a light ring indicator or the like.

In one embodiment, the intelligent charging port is disposed within or on the vehicle such that the intelligent charging port is fully functional at any charging location. In an alternative embodiment, the intelligent charging port may be installed in a home, garage, service center, or repair facility.

The device may be a “stand-alone” charging port where all of the electronics are incorporated into a charge-port body. In one embodiment, the device may be, e.g., an encapsulated module connected to an unmodified standard charging port. In another embodiment, a standard charging port may be modified to include the intelligent charging port but appear to a consumer as a standard charging port. An output-or load-side of the unmodified standard charging port may be connected to a device or component of the vehicle that ordinarily would receive power from the standard port in addition to the intelligent charging port. For example, there may be a split connection or there may be an “in-line” connection. The intelligent charging port may be configured to include a plurality of outputs for connecting multiple loads simultaneously, thereby allowing for simultaneous power delivery on the plurality of outputs or a sequential (e.g., “round-robin”) or patterned power delivery scheme. As such, the present invention may be configured to avoid a problem of overloading a supply circuit that feeds the charge port. These behaviors may be controlled and monitored by the server backend and/or through a mobile, web, or wearable application.

### Intelligent Power Distribution Unit

According to another aspect of the invention, an intelligent power distribution unit is provided. The intelligent power distribution unit may be a connected electronic device that centrally manages, monitors and controls the operation of power accessories within an electric vehicle such as a golf cart or other low-speed vehicle. The smart power distribution unit may be mobile, e.g., disposed within or affixed to the electric vehicle. The smart power distribution unit may be directly or indirectly connected to the vehicle's primary power system, which may be a battery. Such a battery may be a 48V DC battery, or another battery that supplies DC voltage between 36V and 72V. The smart power distribution unit may provide a plurality of output lines, e.g., for controlling power to attached loads and/or accessories. The smart power distribution unit may have an internet protocol-based (IP-based) connection such as a power-over-ethernet (PoE) or a standard ethernet connection. The commands may be used for operation of the smart power distribution unit. In addition or in the alternative, the commands may be used for status-reporting purposes. The smart power distribution unit may be used to provide one or more features related to overload protection, overcurrent protection, or voltage reduction (e.g., voltage reduction to 12 VDC, which may be used by accessories).

The intelligent power distribution unit may be used to control and/or monitor a variety of load devices. Load devices may include, e.g., one or more motor controller power solenoids, vehicle lights, horns, reverse buzzers, electronic parking breaks, or vehicle accessories. Exemplary vehicle lights may include but are not limited to indicator lights, brake lights, headlights, daytime running lights, and underbody or decorative lights such as multi-color LED light strips. Exemplary vehicle accessories may include but are not limited to cigarette lighters, charging ports (e.g., USB charging ports), stereo systems, sound bar devices, and other entertainment devices. Aspects of the present invention provide a user an ability to control and/or monitor each and every one of such loads using one or more applications. The application(s) may run on a mobile device, may be in communication with a back end server, may be a web application, may be a wearable application, and/or may be an application that runs on the vehicle infotainment system.

The intelligent power distribution unit may report load conditions, e.g., for diagnostics, for troubleshooting (which may be guided troubleshooting), and/or to indicate unattended service.

The intelligent power distribution unit may be used to provide, facilitate, or incorporate artificial intelligence (AI) features. In one embodiment, AI may be used to analyze data that is obtained from or available to the intelligent power distribution unit. Data, e.g., charging data, may be input to one or more AI or machine learning algorithms and instructed to obtain optimal charging parameters, and the optimal charging parameters may be either automatically initiated or recommended to an end user, e.g., via a notification system or other indication available via a mobile or web-based application. Furthermore, there may be an ability for the user to select one of a number of predetermined performance criteria that may be used to determine the automatically initiated or recommended charging parameters.

The intelligent power distribution unit may be used to solve a multitude of problems with existing electronic vehicle systems. For example, existing electric vehicle designs fail to incorporate an intelligent, centralized power distribution and control mechanism. Therefore existing electric vehicle designs require the use of standard-style fuse blocks that always provide power to loads unless there is a fault, thus leaving no flexibility or customization for the user. Furthermore, existing vehicle designs require large amounts of bundled wiring and cable harnesses to integrate and connect all of the vehicle's electric components to power and control. These large amounts of bundled wiring and cable harnesses cause higher manufacturing costs, increased complexity (e.g., in fault analysis), increased weight, and wasted power consumption. Moreover existing vehicle systems fail to provide users an ability to easily change vehicle settings for fundamental functions.

In one embodiment, the present invention may include an electronic device comprising a one or more microcontrollers, which may have or be connected to some of all of wireless connectivity circuitry, a plurality of relays for controlling attached loads, protection circuits for attached loads, and an IP-based interface (e.g., PoE interface) for communication with remotely controlled loads. Remotely controlled loads may include, e.g., at least one intelligent vehicle lighting module, which is further discussed below. There may be a primary and secondary (co-processor). There may be an interface with a communication bus such as CAN, and there may be a connection to a main microcontroller, and such connection may communicate using a specific protocol (e.g., UART). There may be a zero-cross detection circuit, which may be fed by load output and neutral wires. The zero-cross detection circuit may detect a signal when voltage is present at the load. A digital signal may be fed to the main microcontroller (e.g., by the zero-cross detection circuit).

The electronic device may operate on power provided by the primary vehicle power system. The power provided by the primary vehicle power system may be 48 VDC, or between 36VDC and 72 VDC. The electronic device may provide 12V of regulated power to attached loads, which may be controlled by a relay bank.

The electronic device may be connected to the vehicle Controller Area Network (CAN) bus or other control network for existing components. The electronic device may derive access to the CAN bus or the like via communication with other attached devices capable of providing such access such as, e.g., an intelligent charging port accessory or an intelligent vehicle lighting module. In addition to a connection to the vehicle CAN bus or the like, the electronic device may further include a wireless interface and/or two-way connections to one or more of a plurality of sensors (e.g., sensors built into the intelligent charging port) such that the electronic device may send and receive information from a variety of sources/components. The connections to and the information from such sources may be analyzed to provide optimal parameters (e.g., charging parameters) and/or may be used to control and report on charging sessions.

The electronic device may interface with a control and signal input/output of the vehicle motor controller, thereby placing the electronic device “in the loop” and allowing for manipulation or transformation of the state presented to the motor controller or the state communicated from the motor controller. Examples of intercepted input/outputs in a typical vehicle include but are not limited to a throttle position sensor; a motor speed sensor; a brake pedal switch; a forward, neutral, and reverse switch or lever; lighting control knobs, dials, or buttons; or a solenoid controller.

The electronic device may include or be connected to a power inverter that supplies 120 VAC shore power. This 120 VAC shore power may be used to supply power to appliances, power tools, or to charge another vehicle for “buddy charging.” So called “buddy charging” may allow the user of the charger vehicle to define a limit on how much charge that user is willing to deplete from their vehicle system before charging disengages at that user-defined point. The user of the charger vehicle may also receive warnings or notifications as their defined limit approaches. In one embodiment, the system may be configured to automatically disengage charging when the user-defined limit is reached. In an alternate embodiment, the system may be configured to continue charging upon reaching the user-defined limit, notify the user of the charger vehicle, and wait for confirmation to disengage load power. Furthermore, the system may provide an ability to select one of a plurality of predetermined charging configurations that govern the buddy charging functionality.

The system may further allow for multiple data sources to be utilized and chained together for creating complex behaviors. For example, daytime running lights may be configured to operate while the vehicle is in motion, and to turn off when the vehicle is either stopped, in park or in reverse. The system may allow for any other similar customization of certain functions based on certain states of the vehicle. In addition to customized operations of the vehicle's lights, the operation of any other load or accessory disposed within or connected to the vehicle may be customized using any number of various factors with different resulting behaviors. In another non-limited example, the system may be configured to redefine the function of control inputs, knobs, dials, or switches, e.g., by assigning such control inputs, knobs, dials, or switches to control different loads with different rules applied.

### Intelligent Vehicle Lighting Module(s)

According to yet another aspect of the present invention, a smart vehicle lighting module may be provided. The smart vehicle lighting module may be an IP-connected module and may include a PoE interface. In one embodiment, the smart vehicle lighting module is installed as a lighting cluster, e.g., on one corner of a vehicle. The smart vehicle lighting module may produce light for one or more tasks. The smart vehicle lighting module may include at least one daytime running light, head light, high beam, turn indicator, reverse lamp, or other visual indication on a vehicle.

The smart vehicle lighting module may include an ethernet cable connected to the aforementioned Smart Power Distribution Unit. This connection may be used to supply power and/or used to send/receive communications for operation.

The smart vehicle lighting module (e.g., lighting cluster) may dynamically adapt its functionality (e.g., lighting functions) depending on where it is disposed on the vehicle. For example, a lighting cluster may adapt its lighting functions depending on which corner of the vehicle the lighting cluster is installed during vehicle assembly, by assignment, or by auto-determination.

In one embodiment, there are a plurality of smart vehicle lighting modules that are configured together, e.g., synchronized with one another. As such, all lighting operations on the vehicle may function together in a comprehensive system, e.g., with all lighting operations functioning simultaneously or in predetermined patterns depending on the system configuration. In one embodiment, one or more smart lighting modules may be replaced or swapped interchangeably with other smart lighting modules, and the new smart lighting module may adapt a predetermined lighting profile, which may be assigned from the Smart Power Distribution Unit.

### Cart Vehicle Operating System and Platform

According to yet another aspect of the present invention, a cart vehicle operating system and platform may be provided. In one embodiment, an operating system (e.g., a unified or linux-like operating system) may connect all communication networks for vehicle systems. The operating system may provide a secure unified standard interface for use within the vehicle by other systems, and the operating system may provide for interacting with a backend server, mobile application, web application, and/or other application(s).

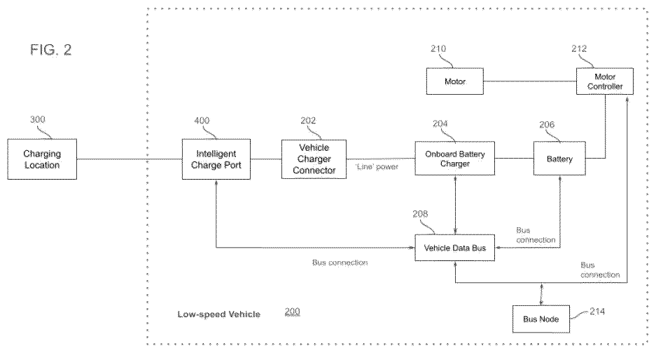

FIG. 2 illustrates an exemplary block diagram of a system for charging and modifying an electric vehicle. The system includes a Low-Speed Vehicle 200, which comprises a plurality of internal components communicating via a Vehicle Data Bus 202 (e.g., a CAN bus). Key components connected to the Vehicle Data Bus 202 may include a Motor 210 controlled by a Motor Controller 208, and one or more Bus Nodes 214 representing other vehicle sub-systems (e.g., battery management systems or infotainment units). The vehicle is shown in the context of a Charging Location 300, where it receives electrical power. The system illustrates the integration of the vehicle's internal architecture with the charging infrastructure, enabling the intelligent monitoring and control features described herein.

As shown in FIG. 2, the charging location 300 is in communication with a low-speed vehicle 200. The intelligent charging port 400 is in communication with a vehicle charger connector 202. In one embodiment, the vehicle charger connector 202 is in communication via an onboard battery charger 204, e.g., via “line” power.

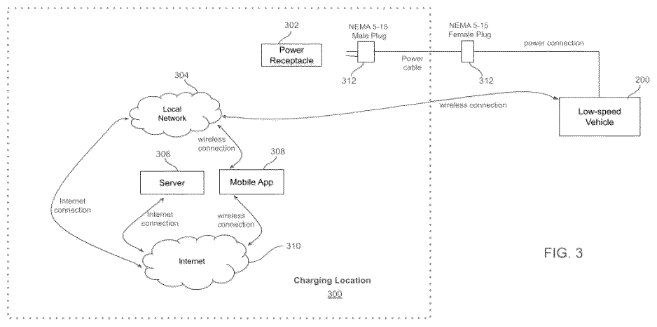

FIG. 3 illustrates a broader network ecosystem involving the Low-Speed Vehicle 200 and a Charging Location 300. The Low-Speed Vehicle 200 connects to an external power source via a Power Cable 312, which may interface with standard NEMA 5-15 plugs and receptacles. The Charging Location 300 is communicatively coupled to a Local Network 302 (e.g., a home Wi-Fi network), which provides access to the Internet 306. This connectivity enables the vehicle or its charging components to communicate with a remote Server 304 (e.g., a cloud-based backend). A Mobile Application 308, running on a user device (e.g., smartphone or tablet), connects to the Server 304 and/or directly to the local network to provide the user with real-time status updates, alerts, and control over the charging process.

FIG. 4 is a detailed block diagram of the Intelligent Charging Port 400. The port acts as an intermediary between the external power source and the vehicle's internal power system.

Power Interface: The device includes a Port Power Connector 416 (e.g., a NEMA 5-15 male receptacle) for receiving line voltage and a Charger Power Mating Connector 414 for delivering power to the vehicle's on-board charger.

Control Logic: A Main Controller & Wireless Module 402 serves as the central processing unit, managing connectivity (Wi-Fi/Bluetooth) and logic. It is supported by a Real-Time Clock (RTC) 410 powered by a backup Coin Cell Battery 412, ensuring that scheduled charging tasks execute even during power outages or network loss.

Safety & Monitoring: A Temperature Sensor 404 monitors thermal conditions to prevent overheating. An Output Detection Circuit 406 (e.g., zero-cross detection) is disposed on the load side to verify the state of the power delivery (identifying, for example, a “stuck relay” fault).

Vehicle Integration: A Bus Transceiver 408 provides the interface between the Main Controller 402 and the Vehicle Data Bus 202, allowing the port to read battery state-of-charge (SoC) and other telematics.

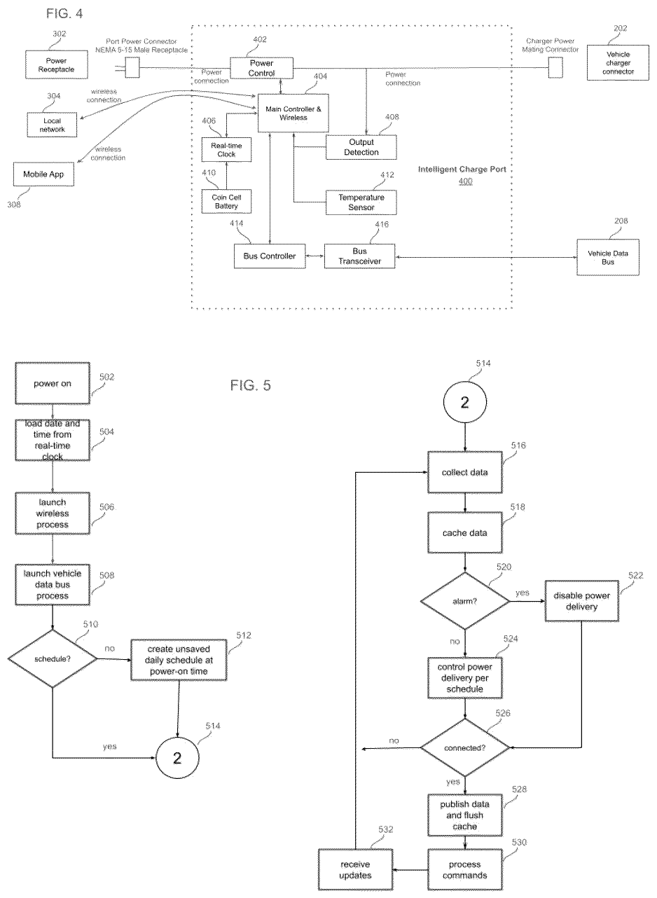

FIG. 5 is a flow diagram illustrating a method 500 for charging and modifying an electric vehicle.

The process begins at Step 502 with the initiation of a charging session, detected via the connection of AC power.

At Step 504, the intelligent charging port monitors operating parameters, such as internal temperature via the temperature sensor and current draw via the detection circuit.

At Step 506, the system determines if a safety fault exists (e.g., over-temperature or mechanical relay failure).

If a fault is detected, the process moves to Step 508, where the switching mechanism is automatically actuated to interrupt power, and a notification is transmitted to the user.

If no fault is detected, the process proceeds to Step 510, maintaining power delivery according to the user-defined schedule or until a target State of Charge (SoC) is reached.

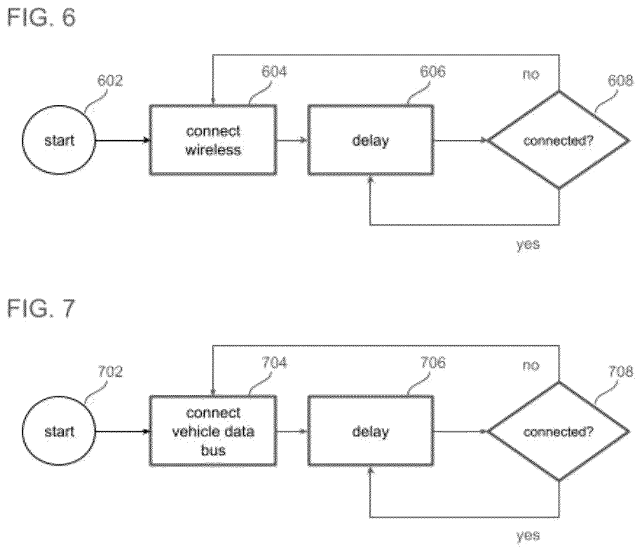

FIG. 6 is a flow diagram illustrating a process 600 for establishing a wireless connection.

At Step 602, the intelligent charging port enters a provisioning mode (e.g., broadcasting a BLE signal).

At Step 604, the mobile application scans for and pairs with the device.

At Step 606, the user provides local network credentials (SSID and password) to the device.

At Step 608, the device establishes a connection to the Local Network 302 and authenticates with the Server 304, synchronizing time and retrieving the latest configuration profile.

FIG. 7 is a flow diagram illustrating a process 700 for interfacing with the vehicle data bus.

At Step 702, the device initializes the Bus Transceiver 408 and detects the protocol of the Vehicle Data Bus 202.

At Step 704, the device requests data packets containing the Battery Management System (BMS) status.

At Step 706, the controller parses the data to extract the current State of Charge (SoC) and battery health.

At Step 708, based on the extracted data, the controller modifies the charging behavior (e.g., terminating charge at 80% to prolong battery life) or sends a command to modify a vehicle performance parameter (e.g., speed setting) if authorized.

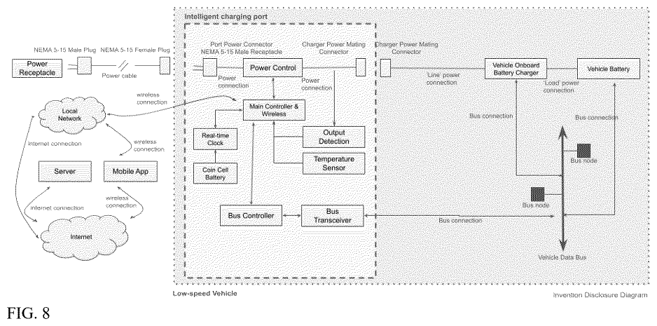

FIG. 8 illustrates the physical disposition of the Intelligent Charging Port 800 within the Low-Speed Vehicle 802. The diagram depicts the port mounted in a specific chassis location 804, such as the vehicle's battery well or under-seat compartment, replacing or augmenting the standard charging receptacle. FIG. 8 illustrates exemplary physical connections to the On-board Battery Charger and the Vehicle Data Bus 806. In one embodiment, the charging apparatus may be a “drop-in” charging apparatus that may be installed “after market” In one embodiment, the charging apparatus upon being installed or equipped may protect the vehicle regardless of where it is plugged in.

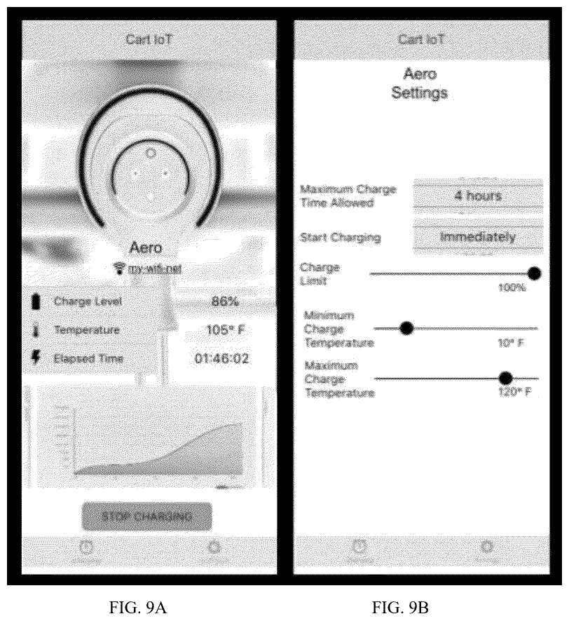

9A and 9B illustrate exemplary user interfaces of the Mobile Application 308. FIG. 9A depicts a graphical user interface (GUI). The GUI may be, e.g., a “dashboard” view. The GUI may display, e. g, real-time metrics such as current battery temperature, charging status (On/Off), and connection health. The GUI may include a toggle control for manually overriding the power state.

FIG. 9B depicts a “Schedule” or “Settings” view. The settings or schedule view may allow the user to, e.g., define “Quiet Hours” for charging, set maximum charge limits, and configure alert thresholds for temperature notifications.

Accordingly, the present invention provides at least one or more of the following advantages:
1. Intelligent features embedded into the components that would traditionally compose a standard charging port receptacle;
2. An ability to detect whether a load voltage is being delivered relative to an on/off state that is requested or commanded;
3. An ability for the charge port to interface to the vehicle bus and utilize data received from it in control decisions;
4. An ability to shut down power delivery within the charge port when unsafe conditions are exceeded;
5. An ability to maintain and execute defined schedules when network connectivity is lost or interrupted;
6. An ability to collect and analyze energy consumption metrics and other performance data from vehicle systems and transmit/store them in a cloud backend, the data being available to artificial intelligence learning modules;
7. An ability to modify other devices'parameters via a mobile application, web application, or server backend, which are connected to a vehicle communication bus (e.g., CAN), and an ability to adjust motor controller parameters of the vehicle thereby modifying, e.g., the vehicle's performance-versus-range capabilities;
8. An ability to send a user reminders via a mobile app and other digital communications channels that a scheduled event may not complete because the device has not connected to a server backend, indicating that the user may not have plugged the vehicle in for charging;
9. An ability to provide a user with notifications regarding power delivery events/status;
10. Setting a specific charge percentage at which to shut off load power to the vehicle power systems, once the set value is read from the vehicle communication bus;
11.A intelligent charging receptacle that leverages artificial intelligence, e.g., by utilizing edge computing and artificial intelligence within the device to suggest optimal performance settings to a user, diagnose potential vehicle system problems, optimizations the user may take, or assist with remote unattended service of the vehicles systems;
12.A intelligent charging receptacle that may be permanently mounted to an electric vehicle;
13.A intelligent charging receptacle that may monitor and control multiple loads; and

It is understood that the present subject matter may be embodied in many different forms and should not be construed as being limited to the embodiments set forth herein. Rather, these embodiments are provided so that this subject matter will be thorough and complete and will convey the disclosure to those skilled in the art. Indeed, the subject matter is intended to cover alternatives, modifications, and equivalents of these embodiments, which are included within the scope and spirit of the subject matter as defined by the appended claims and their equivalents.

For example, an alternative embodiment may have aerial applications. While the embodiments described above primarily illustrate the invention in the context of ground-based low-speed electric vehicles (LSVs), it is to be understood that the charging control apparatus and methods disclosed herein are not limited to terrestrial applications. The novel architecture of the charging control apparatus—specifically the integration of localized fault detection, temperature monitoring, and autonomous switching logic—is equally applicable to electric aerial vehicles, including Unmanned Aerial Vehicles (UAVs), drones, and electric Vertical Take-Off and Landing (eVTOL) aircraft. In such embodiments, the “vehicle state data” received by the controller may originate from a flight controller or avionics bus (e.g., MAVLink) rather than a standard automotive CAN bus, and the “fault condition” may relate to flight-critical parameters such as battery cell imbalance or rotor motor temperature. Accordingly, references to a “vehicle” or “body” within the present disclosure should be interpreted broadly to encompass the fuselages and airframes of such aerial platforms where autonomous, safe charging management is required without reliance on high-voltage ground infrastructure.

Furthermore, in the detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The non-transitory computer-readable media includes all types of computer-readable media, including magnetic storage media, optical storage media, and solid-state storage media and specifically excludes signals. It should be understood that the software can be installed in and sold with the device. Alternatively, the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A charging control apparatus for a low-speed electric vehicle, the apparatus comprising:
a housing configured to be mounted to a body of the low-speed electric vehicle;
a power input connector supported by the housing and configured to couple with an external power source;
a power output connector supported by the housing and configured to deliver electrical power to a battery system of the low-speed electric vehicle;
a switching circuit disposed electrically between the power input connector and the power output connector, the switching circuit having an open state and a closed state; and
a controller comprising a processor and a non-transitory computer-readable memory, wherein the controller is configured to:
receive vehicle state data;
compare the vehicle state data to a stored threshold value; and
transmit a control signal to the switching circuit to transition from the closed state to the open state when the vehicle state data exceeds the stored threshold value.

2. The apparatus of claim 1, further comprising a temperature sensor electrically coupled to the controller, wherein the controller is configured to transition the switching circuit to the open state when a temperature reading from the temperature sensor exceeds a thermal limit stored in the non-transitory computer-readable memory.

3. The apparatus of claim 1, further comprising a voltage detection circuit electrically coupled to a load side of the switching circuit, wherein the controller is configured to generate a fault signal if voltage is detected by the voltage detection circuit while the control signal indicates the switching circuit is in the open state.

4. The apparatus of claim 1, further comprising a real-time clock circuit powered by a persistent internal power store, wherein the controller is configured to transmit the control signal to the switching circuit based on a time value read from the real-time clock circuit.

5. The apparatus of claim 1, wherein the controller is configured to transmit a configuration command to a motor controller of the low-speed electric vehicle via a communication interface circuit to modify a speed parameter stored within the motor controller.

6. The apparatus of claim 1, further comprising a wireless network transceiver electrically coupled to the controller, wherein the controller is configured to receive the stored threshold value from a remote server via the wireless network transceiver.

7. The apparatus of claim 1, wherein the switching circuit comprises a solid-state relay.

8. The apparatus of claim 1, wherein the low-speed electric vehicle comprises a wheeled vehicle having a gross vehicle weight rating of less than 3,000 pounds and a maximum speed capability of less than 25 miles per hour.

9. A method for managing charging of a low-speed electric vehicle, the method comprising:
receiving, at a charging control port mounted to the low-speed electric vehicle, alternating current (AC) power from an external source;
establishing a data connection between the charging control port and a controller area network (CAN) bus of the low-speed electric vehicle;
receiving, via the data connection, battery status data from a battery management system of the low-speed electric vehicle;
measuring, via a sensor integrated into the charging control port, an operating parameter of the charging control port; determining, by a processor within the charging control port, that a fault condition exists when the battery status data exceeds a stored charge limit or when the operating parameter exceeds a stored safety threshold; and
actuating a switching circuit within the charging control port to disconnect the AC power from the low-speed electric vehicle in response to determining that the fault condition exists.

10. The method of claim 9, further comprising: detecting that a network connection to a remote server is unavailable; retrieving a charging schedule from a local memory within the charging control port; and actuating the switching circuit based on a current time maintained by a local real-time clock and the retrieved charging schedule.

11. A low-speed electric vehicle comprising:
a chassis supporting a plurality of wheels;
a rechargeable battery system supported by the chassis;
a drive motor configured to propel at least one of the plurality of wheels using power from the rechargeable battery system;
a data bus configured to transmit vehicle telemetry data; and
a charging control apparatus integrated into the chassis, the charging control apparatus comprising:
a power input connector configured to receive alternating current (AC) power from an external source;
a switching circuit positioned to regulate the AC power flowing to the rechargeable battery system;
a communication interface electrically coupled to the data bus; and
a controller configured to:
monitor the vehicle telemetry data via the communication interface; and
actuate the switching circuit to disconnect the AC power upon detecting that the vehicle telemetry data indicates a critical fault condition.

12. The method of claim 8, wherein the step of measuring the operating parameter comprises monitoring a temperature of the charging control port, and wherein determining that the fault condition exists comprises identifying that the temperature has exceeded a maximum thermal limit.

13. The method of claim 8, wherein the step of measuring the operating parameter comprises performing a zero-crossing detection on a load side of the switching circuit to verify an open state of the switching circuit.

14. The method of claim 8, wherein the step of determining that the fault condition exists is performed while a network connection to a remote server is absent and using a processor-based logic stored locally within the charging control port.

15. The method of claim 8, further comprising transmitting a notification signal to a remote mobile device via a wireless network interface upon actuating the switching circuit.

16. The low-speed electric vehicle of claim 11, wherein the controller of the charging control apparatus is further configured to transmit a configuration command to the drive motor via the data bus to modify a maximum speed setting of the low-speed electric vehicle.

17. The low-speed electric vehicle of claim 11, wherein the critical fault condition comprises a state of charge (SoC) reading from the rechargeable battery system exceeding a user-defined preservation limit stored in a memory of the controller.

18. The low-speed electric vehicle of claim 11, further comprising a power distribution unit communicatively coupled to the charging control apparatus, wherein the power distribution unit is configured to deactivate an accessory circuit of the low-speed electric vehicle in response to a signal from the controller.

19. The low-speed electric vehicle of claim 11, wherein the charging control apparatus further comprises a real-time clock and a backup battery, and wherein the controller is configured to permit the flow of AC power only during a pre-programmed time window.

20. The low-speed electric vehicle of claim 11, wherein the switching circuit comprises a solid-state relay, and the controller is configured to modulate the solid-state relay to reduce current inrush during an initial connection of the AC power.
